(19) United States
(12) Patent Application Publication
(10) Pub. No.: US 2016/0378941 A1
(43) Pub. Date: Dec. 29, 2016

(54) Systems and Methods of Improving Communications Amongst Healthcare Professionals

(71) Applicant: Baylor College of Medicine, Houston, TX (US)

(72) Inventor: Alexander W. Pastuszak, Houston, TX (US)

(21) Appl. No.: 15/195,661

(22) Filed: Jun. 28, 2016

Related U.S. Application Data
(60) Provisional application No. 62/185,635, filed on Jun. 28, 2015.

(51) Int. Cl. G06F 19/00

(52) U.S. Cl. CPC G06F 19/3425; G06F 19/322; G06F 19/327; G06F 19/3418

(57) ABSTRACT

Systems and methods are disclosed for optimizing discrete medical communication and patient care team coordination leveraging diagnosis and patient specific data in the Electronic Medical Records (EMR) and mobile technologies. Relevant patient data for specific communication processes are extracted from the EMR and passed to medical professionals on their mobile devices, and communication regarding specific patient issues facilitated across the entire care team in a secure fashion, with accountability and the ability to track and monitor these processes.

### CROSS-REFERENCE

This application claims the benefit of U.S. Provisional Application No. 62/185,635 filed Jun. 28, 2015, which application is incorporated herein by reference.

### FIELD

The present disclosure generally relates to systems and methods of improved communications amongst healthcare professionals and more particularly to communication systems and methods combining healthcare professional knowledge, mobile technology and enterprise database structures to optimize patient handoff and consultation procedures.

### BACKGROUND

Breakdowns in the communication of critical patient care information during treatment reduce treatment efficiency and quality, increase the risk of medical errors, and ultimately impact the bottom lines of the involved physicians and institutions. Increasing a physician's efficiency is linked to increased patient satisfaction, an improved ability to commit time to critically ill patients, and a decrease in medical errors. The rate of medical errors is rising as a direct result of work hour restrictions and a rising number of patient handoffs, putting patients at risk for suboptimal care. Furthermore, errors are directly linked to the ability of healthcare practitioners to order and interpret appropriate diagnostic tests, and measurable errors cost over one trillion US dollars annually, depending on the variables considered.

With the expected rise in medical care demands coupled with a large influx of new physicians, the need for more efficient communication processes is tantamount to avoiding an even greater rise in treatment inefficiencies and medical errors. Numerous studies have projected a physician shortage and with the Patient Protection and Affordable Care Act set to give thirty two million Americans access to health insurance, baby boomers' increased needs for medical care as they age, and the likelihood of retirement for an aging physician workforce, concerns have only increased in recent years.

When physicians transfer patient care responsibilities to one another, such as at the end of a day or shift, there is significant inefficiency as well as a high risk of data loss and error in data transfer due to the primarily manual data transfer process. Currently, this handoff process is accomplished by email, text, or phone communications between physicians, and is unstructured. For example, if a busy physician wishes to hand off his service to another physician for the night or weekend, the transferring physician will either email or text the details of each patient to the on call physician or verbally transfer these data, depending on the specialty and the preferences of the physician. There is typically no preset structure to the data, and whether all essential patient data are transferred during each handoff is questionable given this lack of structure and accountability in the current process. In fact, with new work hour restrictions on residents, the number of patient handoffs has increased, with a concomitant increase in the risk of medical errors, and no current methods to monitor the patient handoff across all residents or other healthcare professionals. Furthermore, the handoff process can take several minutes per patient, with a busy service requiring upwards of forty five minutes to hand off using current techniques.

The Emergency Medicine Patient Safety Foundation (EMPSF) spearheaded the creation of the “Safer Sign Out” program that developed a structured, albeit paper-based, process and established protocols for a more efficient handoff (www.safersignout.com). Another initiative, I-PASS, created a standardized, evidence-based handoff program comprising team training, a verbal mnemonic, and a structured printed tool, has also shown efficacy in decreasing medical errors.

An electronic medical record (EMR) is a collection of data about a patient's medical history which may include the patient's medication and allergies, immunization status, laboratory test results, radiology images, physician and other healthcare provider notes, vital signs, demographic data, and billing information. It allows for an entire patient history to be viewed without the need to track down the patient's previous medical record volume and assists in ensuring data is accurate, appropriate and legible. Currently, an EMR is accessible through workstations within a hospital environment and using secure remote access. Limited access is available on mobile devices as well.

A busy Emergency Department (ED) physician typically sees upwards of twenty patients per twelve-hour shift in a bustling environment with many distractions, often being pulled in numerous directions by staff and patient care issues. When the ED physician sees a patient requiring specialty service consultation, he or she must first identify a consulting physician, which may require manually going through a physician directory. Once the consulting physician is identified, the ED physician pages that physician and waits for a response, which translates to lost time for the ED physician, who can otherwise be engaged in caring for other patients. When the ED physician's call is returned, a conversation ensues that can take ten or more minutes per patient but may take place over a much longer time period due to each party being involved in the care of other patients. This communication requires the ED physician to accurately communicate data pertinent to the patient's problem in order to provide the consulting physician with enough information to assess the patient.

Typically, this conversation is driven by the consulting physician, who requests the discrete elements of each patient problem. Once this conversation is done, the ED physician then waits for the consulting physician to arrive and determine a disposition for the patient, which may incur additional inefficiency. In fact, during an ED physician's twelve hour shift, over an hour is spent communicating with consulting physicians about patient care, transferring the type of data described above. Moreover, the consulting physician frequently splits his or her time between caring for his or her patients, often located in several hospitals, administering his or her practice, and responding to consults from various sources including the ED and the hospital floors and intensive care units.

A busy consulting physician may have upwards of thirty patients he or she is caring for at any given time, and if caring for a large service, such as that in a busy trauma center or academic medical center, may have even more. Thus, keeping track of numerous patients at several different hospitals can be challenging, and is currently done using paper or the patient list system in the hospital EMR, which typically does not transfer between hospitals. When a consulting physician receives a page from an ED physician who is requesting the consulting physician see a new patient, the consulting physician must devote the time to obtaining the essential patient information he or she needs to address the patient's specific problem.

If this process could be made more efficient, the ED physician's time could be reallocated to patient care, resulting in improved quality of care and increased revenue for the physician and hospital. In addition, if the accuracy of the data the ED physician transmits to the consulting physician were ensured, fewer medical errors would result.

Both handoff and consultant communication are currently time consuming and subject to error as a result of the current process. Both are costing time and money for the hospital and physicians and affecting patient care delivery.

The handoff process can take thirty minutes or longer, depending on the number of patients and details, adding up to a significant time commitment in a busy clinical setting. The consultation process may require several contact attempts and can be spread over an hour or more per patient, impacting the time that both the ED and consulting physician have to attend to other patient care matters. In addition, other discrete communication processes, such as queries from nurses to physicians or physician extenders regarding specific patients, direct communication between patients and physicians, and more broadly communication and coordination of care between the diverse medical specialties caring for patients with complex illnesses, further limit the optimization of patient care throughout the healthcare system. Verbal transfer of information may be inaccurate, increasing the risk of medical errors especially with the physician “handing off” the information having been on duty for ten plus hours. Physicians managing information for multiple patients located in different hospitals become more complicated and keeping track of all patients can be confusing. The inefficiency of and inability to track these communication points limits the optimization of these processes, affecting quality of patient care.

### SUMMARY

Additional features and advantages of the present invention will be set forth in the description which follows, and in part will be obvious from the description, or can be learned by practice of the herein disclosed principles. The features and advantages of the disclosure can be realized and obtained by means of the instruments and combinations particularly pointed out in the appended claims.

Disclosed are systems and methods for optimizing discrete medical communication by leveraging diagnosis and patient specific data in Electronic Medical Records (EMR) and mobile technologies. Relevant patient data for specific communication processes are extracted from the EMR and passed to medical professionals on their mobile devices, enabling communication regarding specific patient issues in a secure fashion, with accountability and the ability to track and monitor these processes.

In one embodiment, a communication platform optimizes the patient handoff process, providing structure and automated extraction of relevant patient data from the EMR based on diagnosis. Data is sent to an accepting physician and the patient care team in a secure, HIPAA-compliant fashion, is reviewed and patient care responsibility accepted. Additional data may be obtained through search of the EMR and the communication between patient care team members is tracked, permitting a consensus on patient care for each patient, resulting in a highly efficient, tracked process that permits accountability for all parties involved.

In another embodiment, a communications platform sends essential data that a consulting physician needs, based on a patient's specific diagnosis and automatically extracted from the hospital's EMR, to the consulting physician in a secure, HIPAA-compliant fashion, significantly decreasing the amount of time needed to obtain such data via a conversation.

In another embodiment, a communications platform tracks the communication between an requesting physician and a consulting physician to minimize both physicians' distraction from caring for their patients, and automatically alerts the requesting physician of the consultant's arrival at the patient's bedside.

In another embodiment, systems and methods for patient handoff follow the Safer Sign Out and I-PASS structures delivered in electronic format, reconfirming the need as well as validating the workflow.

In another embodiment, systems and methods provide integration with the EMR, permitting data extraction, eliminating data transcription errors and saving time.

In another embodiment, systems and methods provide the ability to add verbal or typed notes.

In another embodiment, systems and methods enable rapid and convenient review and management of handoffs and consultations on multiple patients from multiple locations.

In another embodiment, a user may initiate and manage communication from a single application via their preferred method e.g. phone call, voice message, text message, or page.

### BRIEF DESCRIPTION OF THE DRAWINGS

The following drawings, in conjunction with detailed description, help clarify the features and advantages of the present disclosure. In the figures, similar components are identified using the same reference label. Multiple instances of the same component in a figure are distinguished by adding a second reference label.

FIG. 1 illustrates an exemplary but not exclusive communications platform for patient data transfer among healthcare practitioners, practiced in accordance with the principles of the present invention.

FIG. 2 illustrates a workflow diagram practiced in accordance with the principles of the present invention for a patient handoff procedure.

FIGS. 3a-3j illustrate exemplary but not exclusive screen shots of the exemplary user interface and templates displayed on the mobile device 102 for a handoff procedure.

FIGS. 4a and 4b illustrate a workflow diagram practiced in accordance with the principles of the present invention for requesting a patient consultation.

FIG. 5 illustrates a workflow diagram practiced in accordance with the principles of the present invention for responding to a patient consultation request.

FIGS. 6a-6m illustrate exemplary but not exclusive screen shots of the exemplary user interface and templates displayed on the mobile device 102 for a consultation procedure.

### DETAILED DESCRIPTION

The FIGs and text below, and the various embodiments used to describe the principles of the present invention are by way of illustration only and are not to be construed in any way to limit the scope of the invention. A Person Having Ordinary Skill in the Art (PHOSITA) will readily recognize that the principles of the present invention maybe implemented in any type of suitably arranged device or system. Specifically, while the present invention is described with respect to use in certain networks and devices therein, a PHOSITA will readily recognize other types of networks and devices without departing from the scope of the present invention.

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by a PHOSITA to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

There is a need for a communications platform that engages mobile technology and leverages the mandated transition to the electronic medical record (EMR) to reduce inefficiencies at critical communication points of patient data transfer between healthcare practitioners.

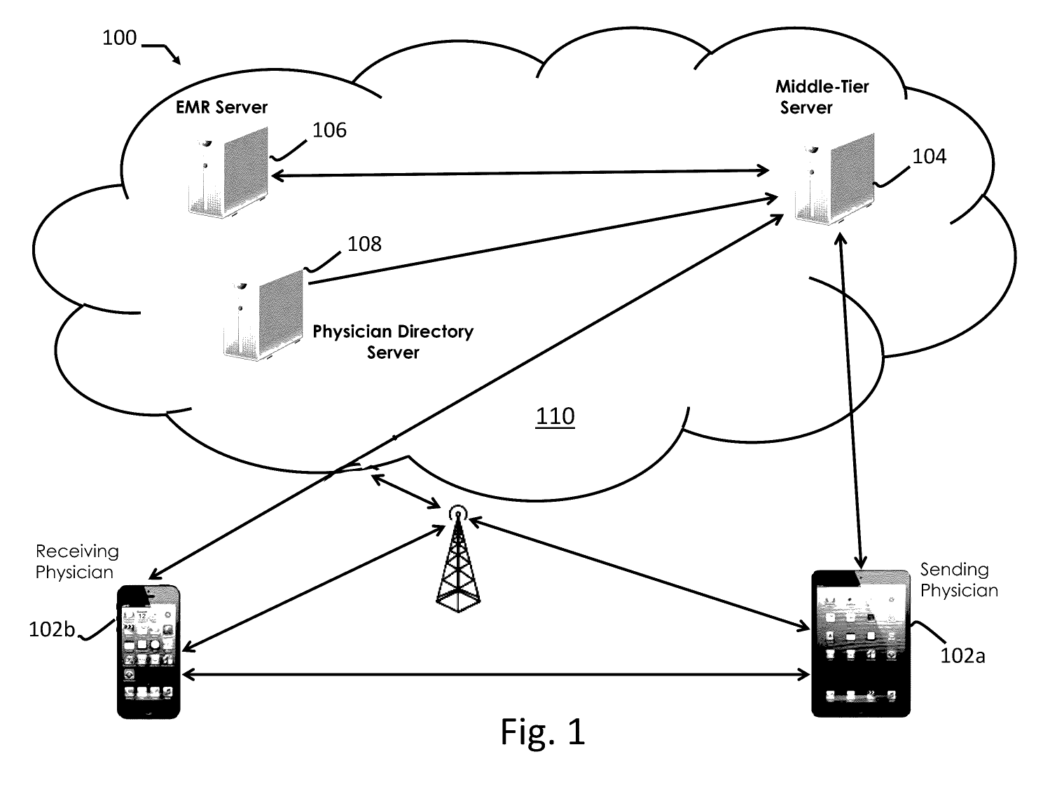

Reference is now made to FIG. 1 illustrating an exemplary but not exclusive communications platform 100 practiced in accordance with the principles of the present invention for patient data transfer between healthcare practitioners. Communications platform 100 includes at least one mobile client device 102 (102a and 102b are depicted as sending and receiving physician devices, respectively) for supplying and receiving patient data, a middle-tier server 104 networked to the at least one mobile device 102, an EMR server 106 having an electronic medical record database and networked to the middle-tier server 104, for serving patient medical records and for storing completed healthcare practitioner input, and a physician directory server 108 networked to the middle-tier server 104, for serving physician availability data. It is to be understood that the physician directory server 108 may accommodate the call schedule indicating which physician is on call for a specific specialty at a given time. It is also to be understood that EMR server 106, and a physician directory server 108 can be combined into a single server having a database that supplies both EMR and physician directory services without departing from the scope of the present invention. In some embodiments the communications platform will also encompass a virtual education module designed to accomplish the following: 1) virtual education relating to communication processes requiring transfer of patient data and communication between healthcare professionals; 2) virtual education pertinent to specific clinical topics; 3) real-time access to human expertise and the clinical evidence base pertinent to specific clinical topics.

It is also to be understood that middle-tier server 104, electronic medical record server 106, and a physician directory server 108 can be dedicated servers within a hospital or institutional environment or may also individually or collectively be a cloud-hosted virtual machines in a cloud based computing service 110 such as those provided by Amazon Web Services, Google, Microsoft or any other suitable cloud computing solution without departing from the scope of the present invention.

The at least one mobile client device 102 can be any suitable mobile device with cellular, Wi-Fi or other suitable wireless network technology such as, but not limited to, an iOS device (e.g. iPhone® or iPad®) from Apple Inc. of Cupertino, Calif., an Android device (e.g. Galaxy S®, Galaxy Note® or Galaxy Tab Note®) from Samsung Electronics of South Korea, a Microsoft mobile wireless device (e.g. Surface tablet) or any other capable smartphone or tablet device.

The middle-tier server 104 handles requests from the at least one mobile client device 102, shielding client devices (e.g. 102a and 102b) from the complexity involved in dealing with the electronic medical record (EMR) server 106 and physician directory server 108. As described in more detail herein below, the middle-tier server 104 supplies the at least one mobile client device 102 with, inter alia, unpopulated templates for filling out various patient data and for serving up populated templates. Alternatively, the templates are automatically populated with data from the EMR. As described herein below, the template associated with a patient may include written or verbal notes from an attending physician as well as other communication such as status from handoff and consultant sessions. The physician directory server 108 is networked to the middle-tier server 104 to supply physician availability data, which in turn can be relayed to the at least one mobile client device 102. The middle-tier server 104 is also networked to the EMR server 106 to receive data feeds such as patient information, lab and imaging reports and other relevant data. In return, the middle-tier server 104 supplies the EMR server 106 with completed handoff and consultant reports. At least one mobile client device 102 may be networked together and to the respective servers via a cellular, Wi-Fi or other suitable wireless network technology.

### Hand-off Workflow

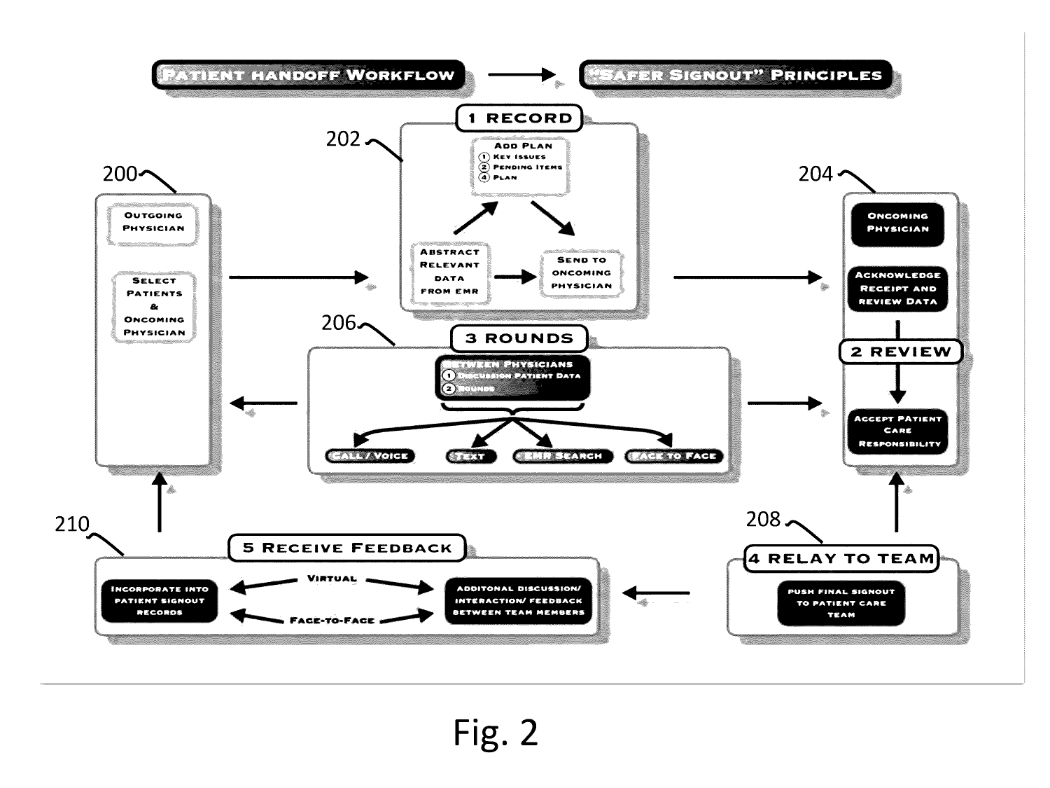

Reference is now made to FIG. 2 depicting a workflow diagram practiced in accordance with the principles of the present invention for a patient handoff procedure. The hand-off functionality of middle-tier server 104 preferably is applied to any healthcare provider, including but not limited to, healthcare providers of all medical specialties within a hospital, between healthcare providers at hospitals or healthcare institutions separated by geography or business relationships, between healthcare providers at healthcare institutions providing acute medical care and those at institutions providing subacute, rehabilitational, nursing, or other non-acute patient care. At step 200, an outgoing physician accesses the middle-tier server 104 using any available computing device having connectivity to server 104, whether it is a wired workstation (not shown in FIG. 1), a wired or wirelessly connected laptop computer (also not shown in FIG. 1) or a mobile wireless device 102 (depicted in FIG. 1). The physician selects the list of patients whom he or she needs to hand off to the oncoming physician, and at step 202 initiates automated extraction of essential handoff data from a database on the EMR server 106 based on diagnosis. The outgoing physician is then able to edit the data and add any essential care points not available in the EMR server 106, and then pushes the list of patients and patient care data to the oncoming physician in a secure, HIPAA-compliant fashion.

At step 204, the oncoming physician acknowledges receipt of the handoff assignment, reviews the data sent by the outgoing physician, and if appropriate, accepts patient responsibility. At step 206, the oncoming physician is able to discuss each patient, if needed, with the outgoing physician handing the patient off using several modalities, including text message, phone call, or voice drop, and is able to further search the EMR server 106 for additional patient data that can then be securely, efficiently, and directly incorporated into the handoff record for each patient. It is understood that the data review and communication can occur prior to, concurrent with, or after acceptance of patient care responsibility. In addition, all patient handoff data can be easily shared with all members of the patient care team, including nurses and physician extenders, to ensure that the patient care plan is known and understood by all stakeholders. At step 208, the final sign-out is pushed out to the patient care team. Virtual and face to face feedback between the patient care team may be made at step 210 and incorporated into the patient hand-off records.

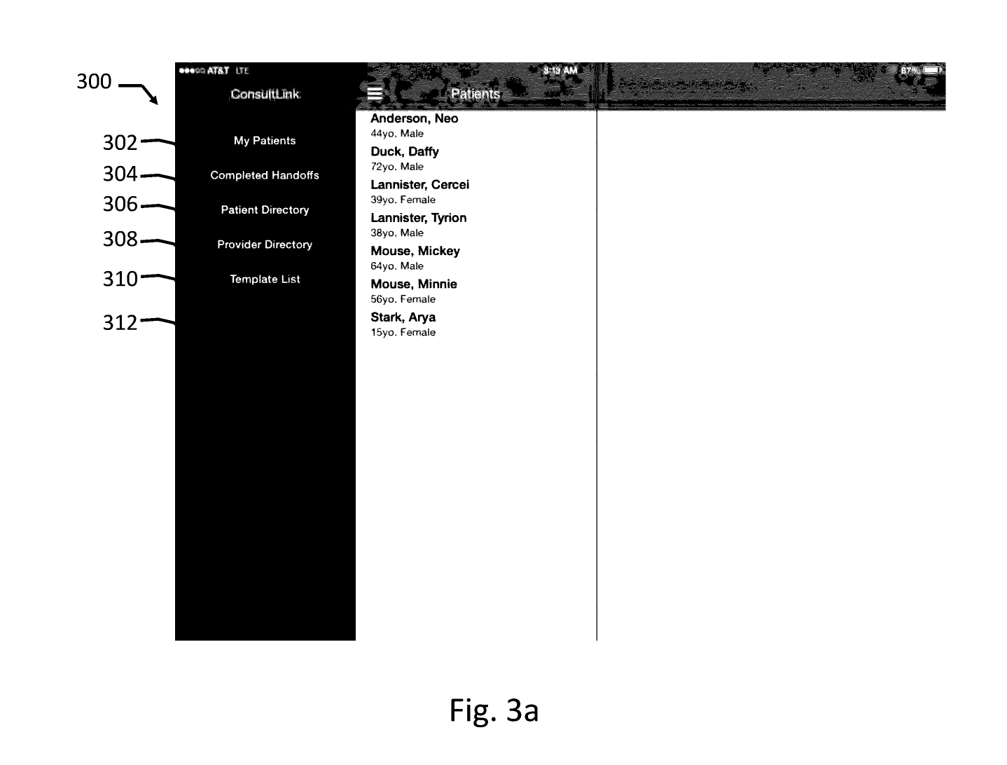

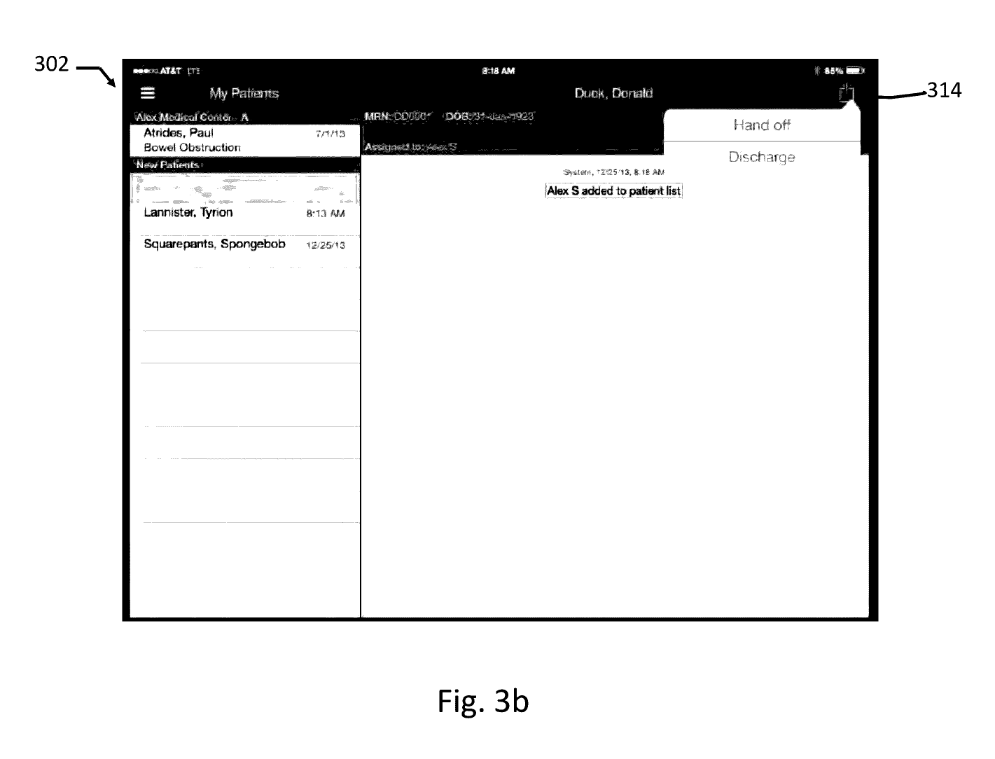

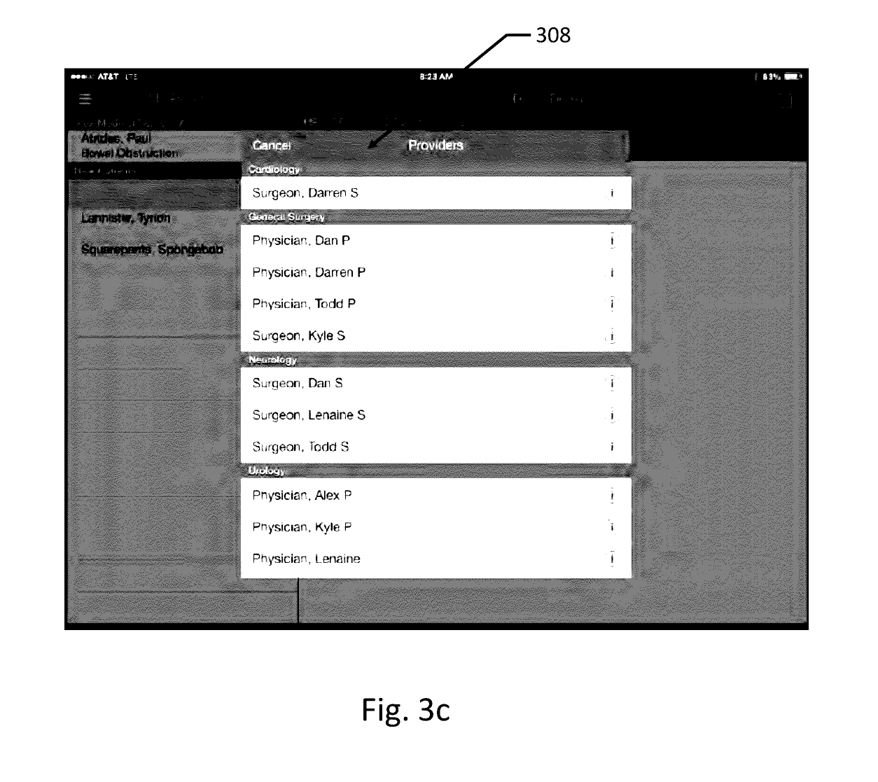

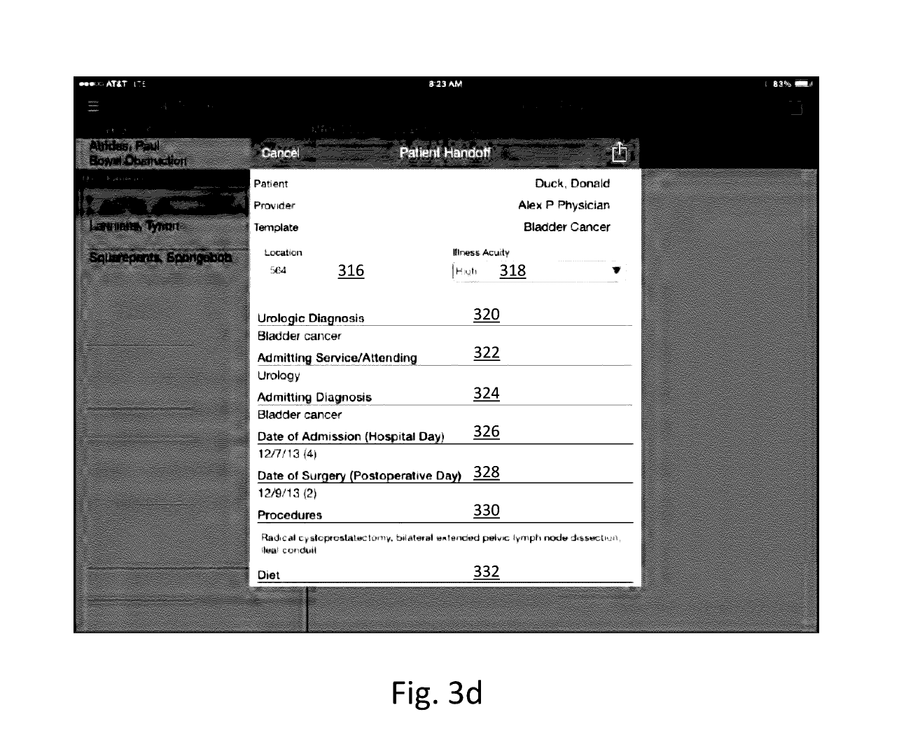

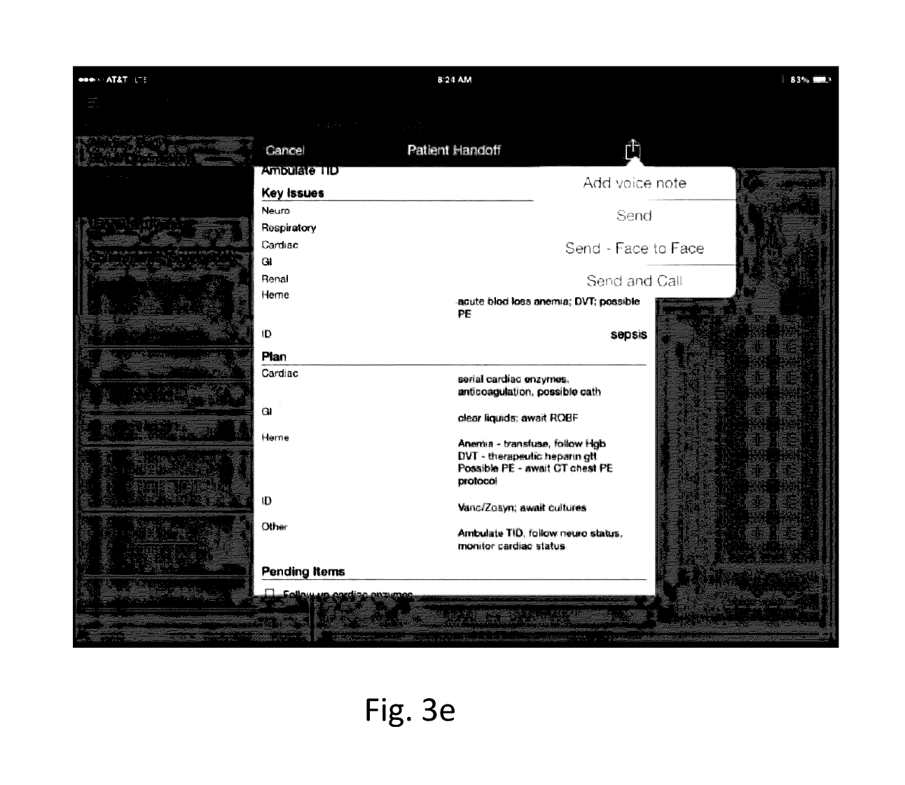

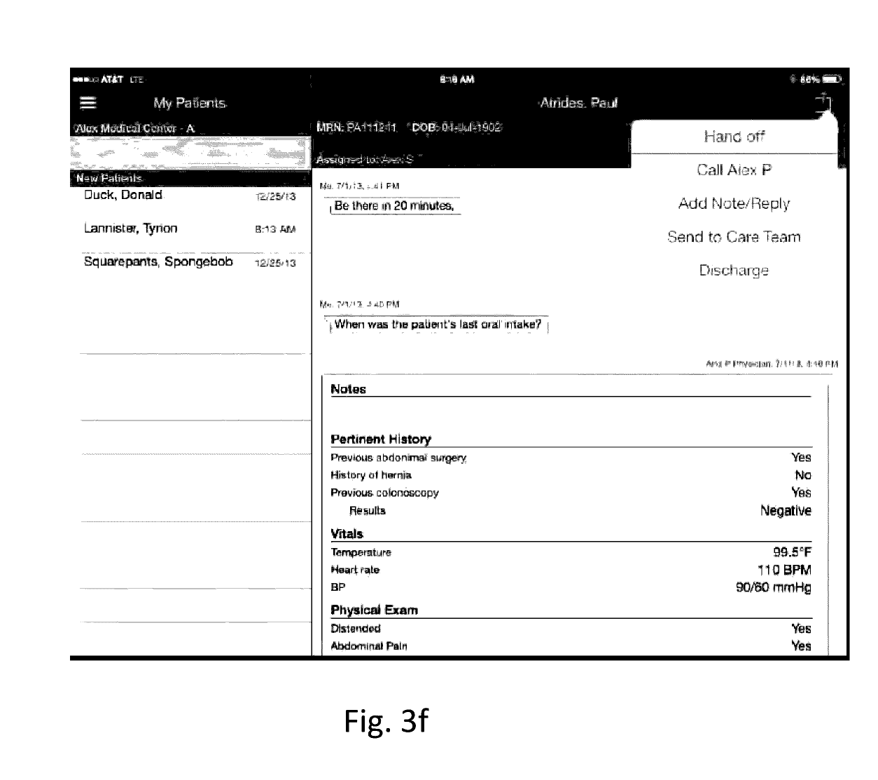

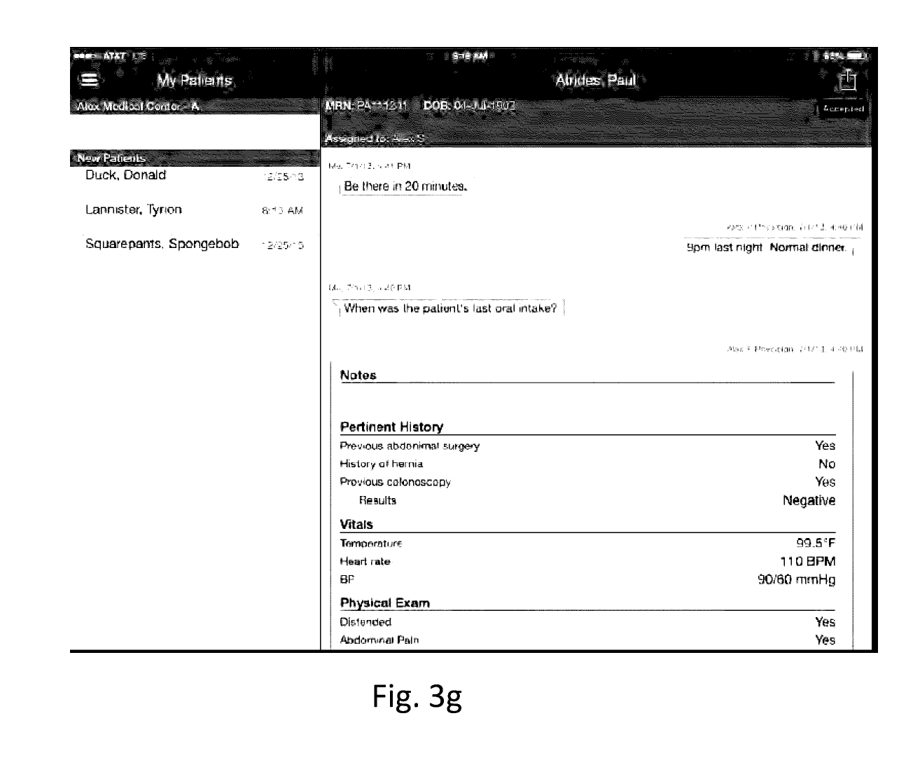

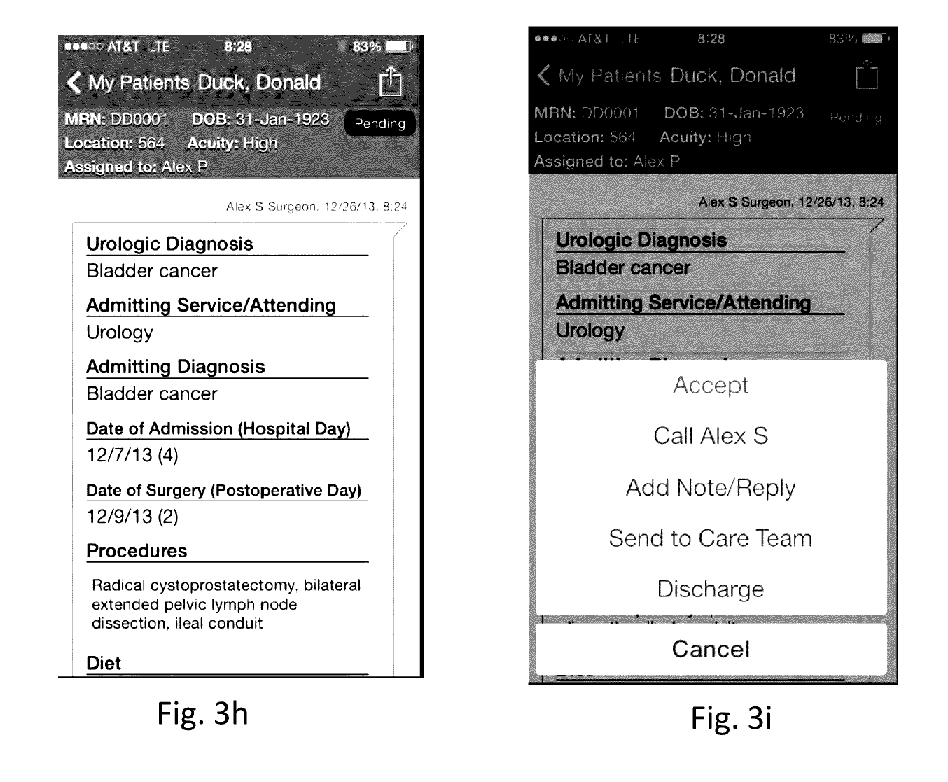

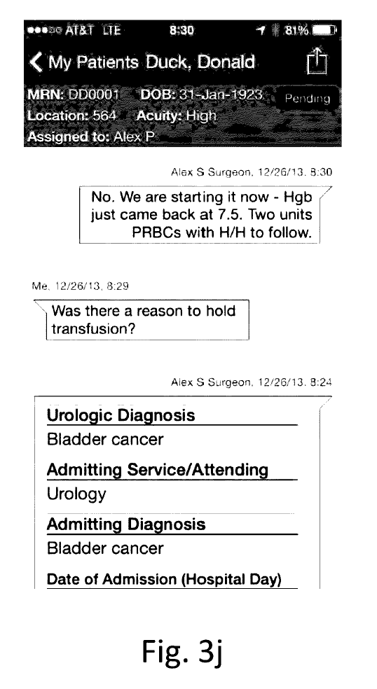

Reference is now made to FIGS. 3a-3j illustrating exemplary but not exclusive user interfaces and templates displayed on the mobile device 102 for a handoff procedure. While selective interfaces and templates will be discussed, it should be understood that the entire spectrum of patient care data and communication may be captured and used to track and review the patient handoff process within each hospital down to the single physician level. Furthermore, handoff data for each patient for each day of the patient's hospitalization may be readily available for review in electronic format for any physician on the patient care team, providing a basis for clinical decision making and improving efficiency.

FIG. 3a illustrates a main menu 300 having a submenu for a list of assigned patients 302, a list of completed handoffs 304, a patient directory of all patients 306, a provider directory 308, and a list of available templates 310. Field 312 depicts which physician is currently logged in.

FIG. 3b illustrates submenu 302 for assigned patients in more detail. Submenu 302 is bifurcated into existing and new patient fields. Pull down menu 314 permits the currently logged in physician depicted in field 312 to handoff or discharge the selected patient highlighted in submenu 302.

FIG. 3c illustrates in more detail, the submenu 308 of a list of available providers.

FIG. 3d illustrates an exemplary bladder cancer template from the list of available templates 310. The exemplary but not exclusive template includes a patient location field 316, a level of illness acuity field 318, a urologic diagnosis field 320, an admitting service field 322, an admitting diagnosis field 324, a date of admission field 326, a date of surgery field 328, a procedures field 330 and a diet field 332. While the template fields described above were specifically tailored for bladder cancer, it should be understood that each template in template submenu 310 preferably has general fields applicable across all illnesses as well as fields specifically relevant to the diagnosis. It should also be understood that any pending item field may be automatically updated through an interface with the EMR server 106 as pending items are completed, alerts sent to the user, and results viewed directly, thus facilitating patient care. FIG. 3e illustrates the continuation of the exemplary bladder cancer template, illustrating fields for Key Issues, patient care Plan, and a list of Pending items for completion, all of which are generalizable to other conditions. FIG. 3f illustrates the communication between physicians on a given patient, as well as the communication options (phone call, note/voice reply) and ability to send the hand-off to the entire patient care team. FIG. 3g illustrates a hand-off that has been accepted by the receiving physician, with continued communication. FIGS. 3h illustrates a hand-off template that has been sent to a receiving physician but not yet accepted, as viewed on an iPhone, and FIG. 3i illustrates the communication options available to the receiving physician. FIG. 3j illustrates the communication between physicians on a patient prior to acceptance of patient care responsibility for that patient.

### Consultation Workflow

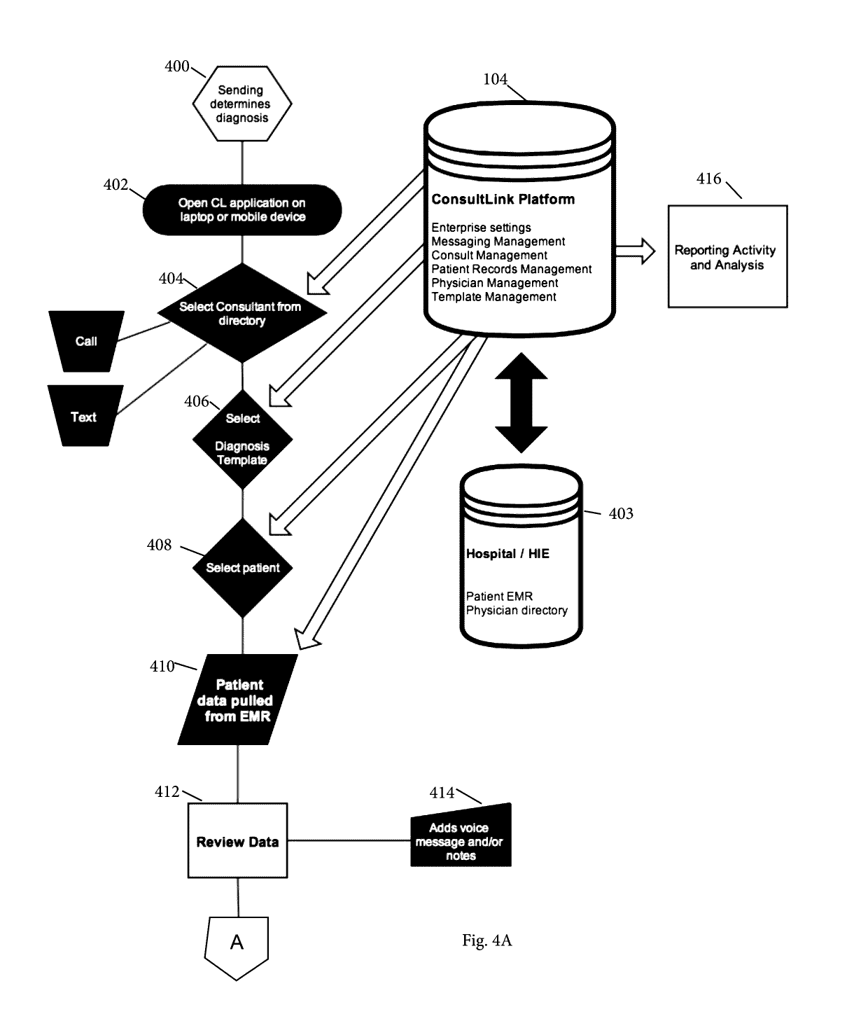

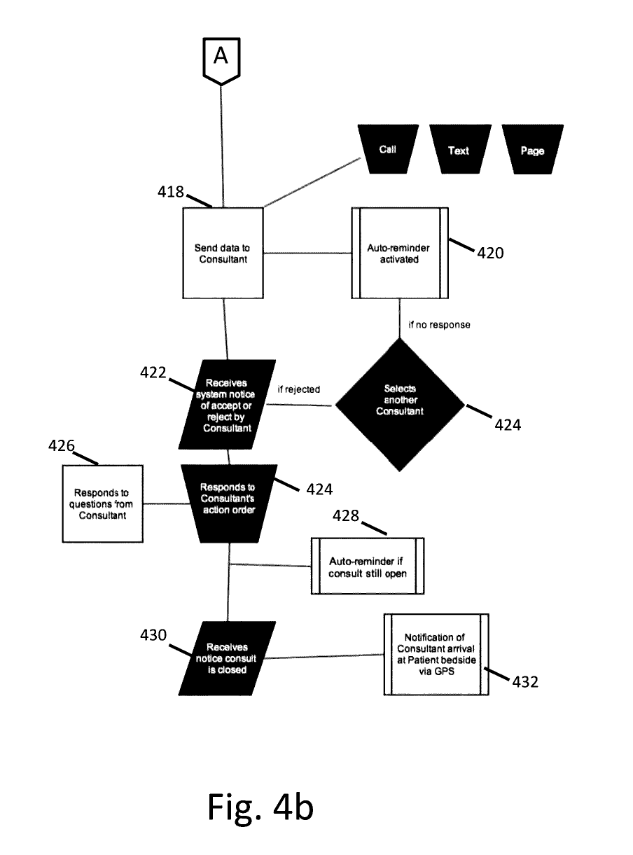

Reference is now made to FIGS. 4a and 4b illustrating a workflow diagram practiced in accordance with the principles of the present invention for requesting a patient consultation. Step 400 is the communication point when a physician has made a diagnosis that requires a specialty physician to provide further evaluation and care for the patient. The requesting physician initiates the request consultation process by opening an application (a.k.a. computer program) either on a workstation, laptop computer or mobile device appropriately networked to the middle-tier server 104 at step 402. At step 404, the requesting physician selects an appropriate specialty consulting physician from a directory of available consulting physicians served up by middle-tier server 104 from database 403 and initiates the request by call, text or other appropriate communication. The requested consulting physician may be on hospital staff or in separate practice with privileges at the hospital where the patient is being seen.

The requesting physician then selects diagnosis and patient templates at steps 406 and 408 respectively, served up by middle-tier server 104. At step 410, middle-tier server 104 populates patient EMR data pulled from database 403. Requesting physician then reviews patient EMR data and may add or supplement it by adding a voice message or electronic notes at step 414. Middle-tier server 104 may report out activity and analysis at step 416.

At step 418, the requesting physician sends out the data reviewed in step 412 and supplemented in step 414 by one or more modalities of call, text or page to the requested consulting physician. An auto-reminder may be activated at step 420 to watchdog whether the consulting physician responds. At step 422, the requesting physician receives notice of the consulting physician's acceptance or rejection. If the consulting physician rejects the request or the auto-reminder at step 420 times out due to lack of response, the requesting physician or a system auto-escalation mechanism selects another consulting physician and repeats the process at step 404.

If the consulting physician accepted the assignment at step 422, the requesting physician either responds to the consulting physician's action order at step 424 or questions at step 426. Step 428 is another auto-reminder to alert the requesting physician that the consulting physician accepted the assignment at step 422 but has yet to issue an action order at step 424 or questions at step 426. Step 430 alerts the requesting physician that the consultation is closed and step 432 notifies the requesting physician that the consulting physician has arrived at the patient's bedside such as with Global Positioning System (GPS) or by micro-location Wi-Fi techniques, preferably on the consulting physician's mobile device 102.

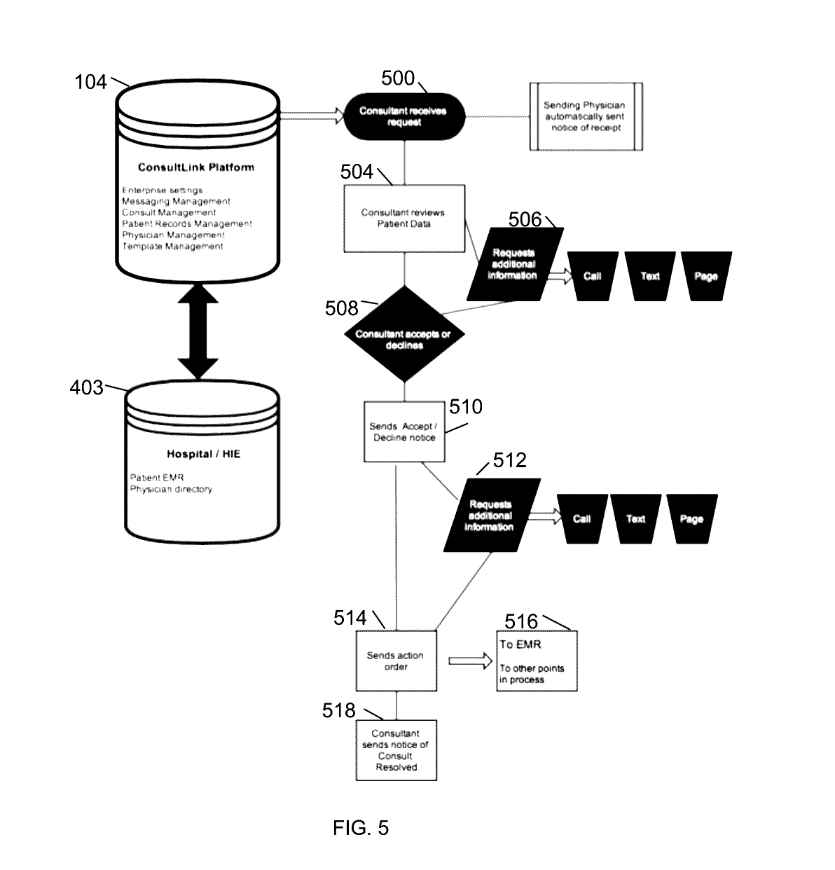

Reference is now made to FIG. 5 illustrating a workflow diagram practiced in accordance with the principles of the present invention for responding to a patient consultation request. At step 500 the consulting physician receives the request for consultation from the requesting physician. A notice of receipt by the consulting physician is automatically sent to the requesting physician at step 502. At step 504 the consulting physician reviews the patient data pulled by middle-tier server 104 from database 403 and potentially supplemented by the requesting physician as described herein above. The consulting physician either accepts or declines the request at step 508 or may request additional information at step 506 using several modalities, including text message, phone call/voice drop, page, or EMR search. At step 510, notice is sent to the requesting physician of the decision made at step 508. The consulting physician may request additional information from the requesting physician at step 512 using several modalities, including text message, phone call/voice drop, or page, or alternatively via EMR search, before issuing an action order on the patient at step 514. At step 516, the consulting physician's action order from step 514 is sent to the EMR database 403 serviced by servers 104 and 106. The consulting physician sends notice that the consultation was resolved at step 518.

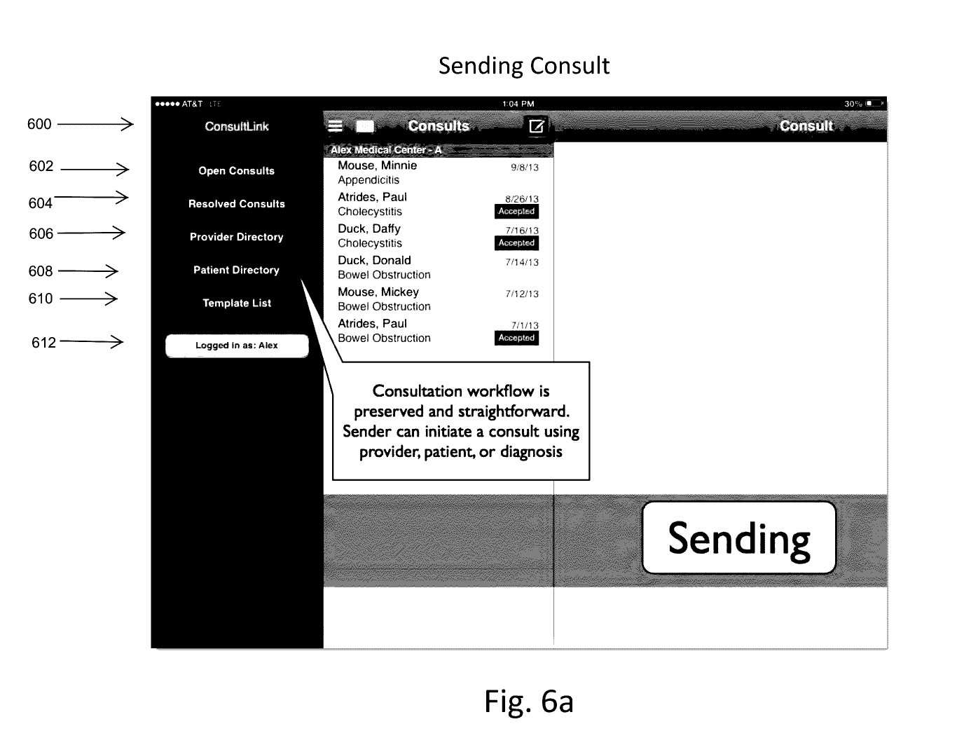

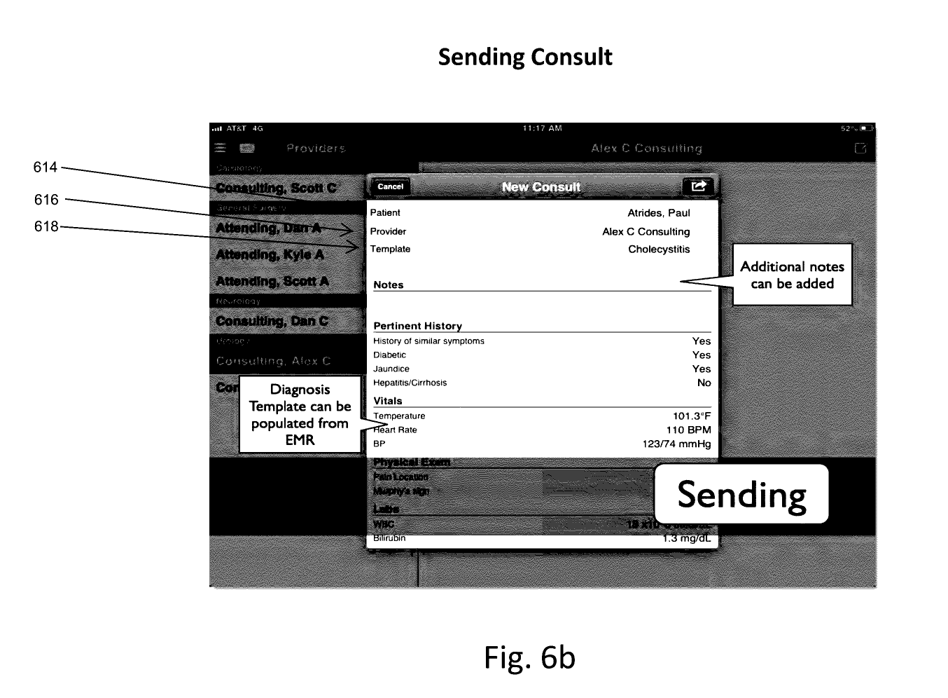

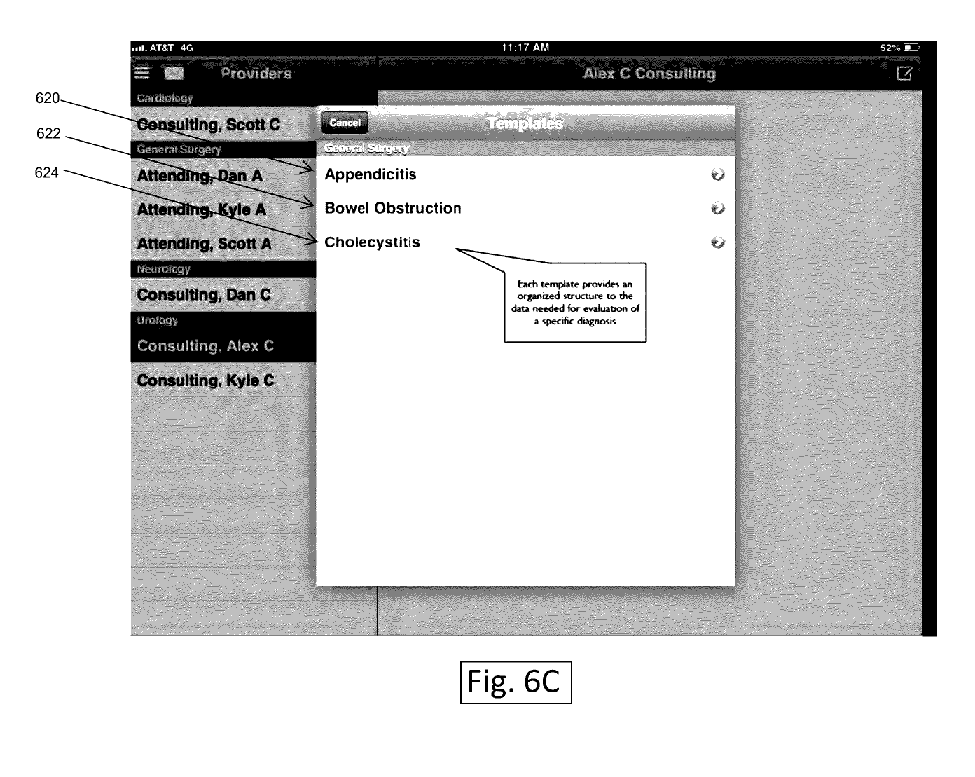

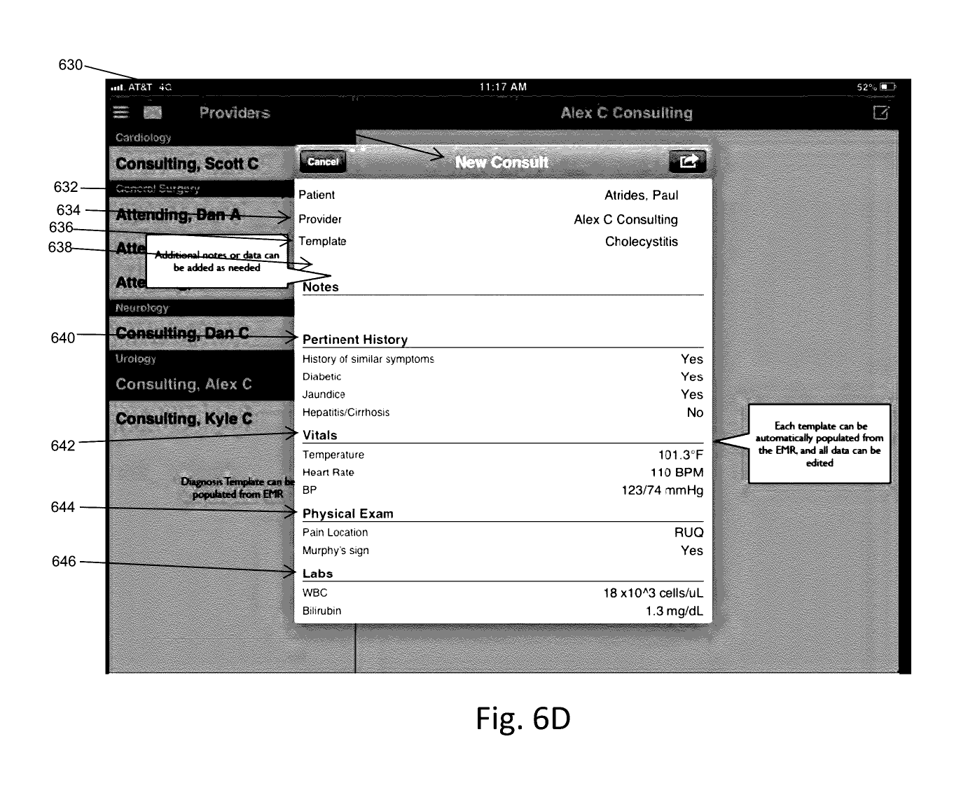

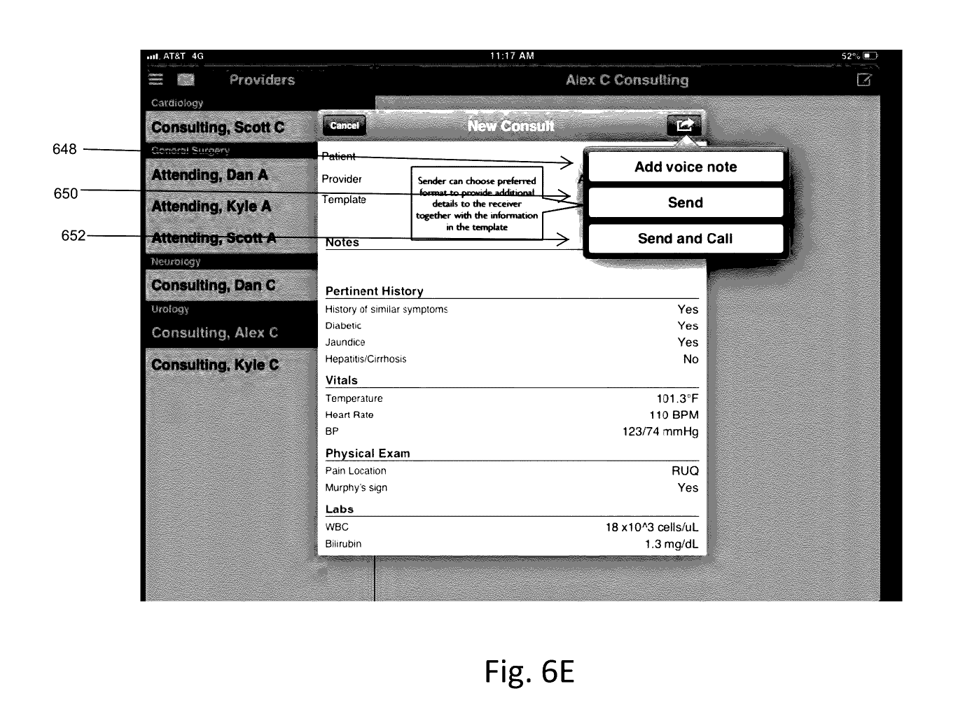

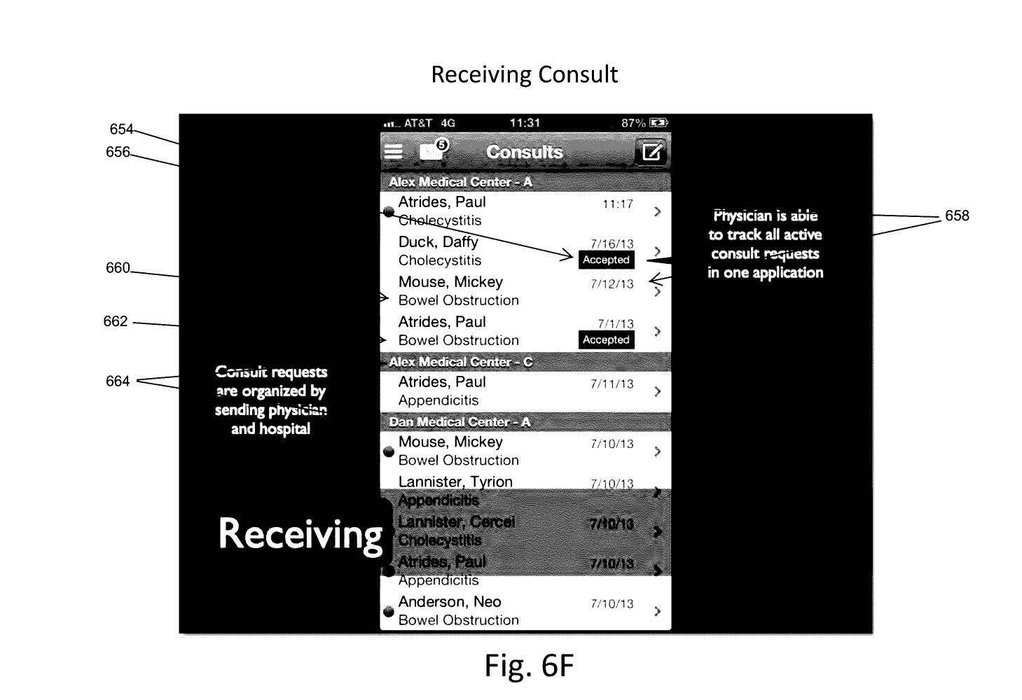

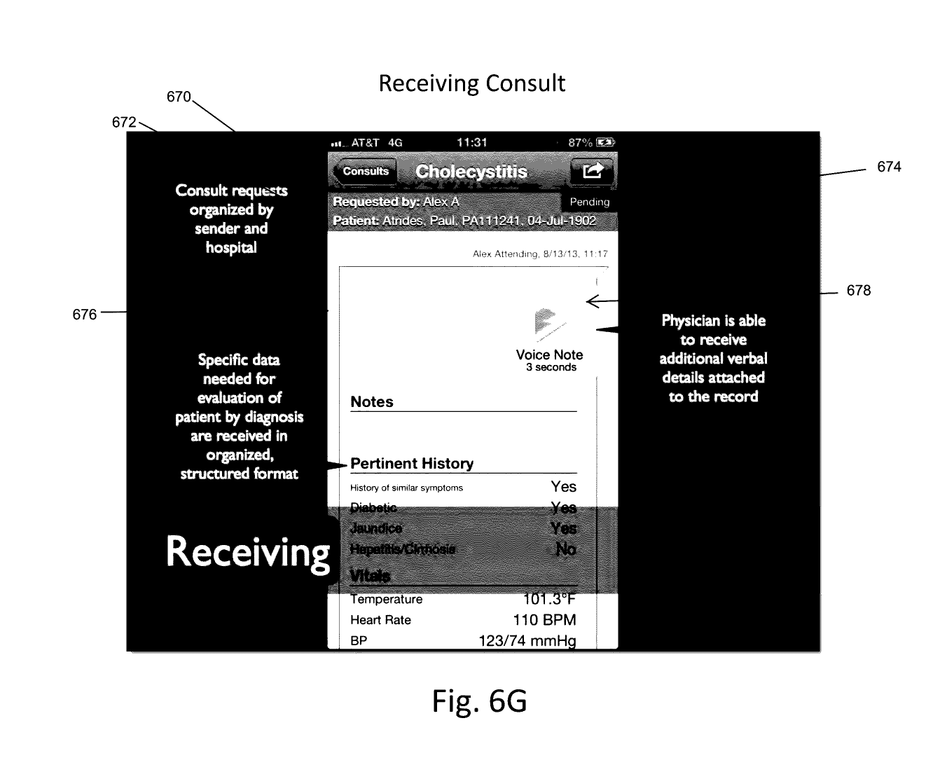

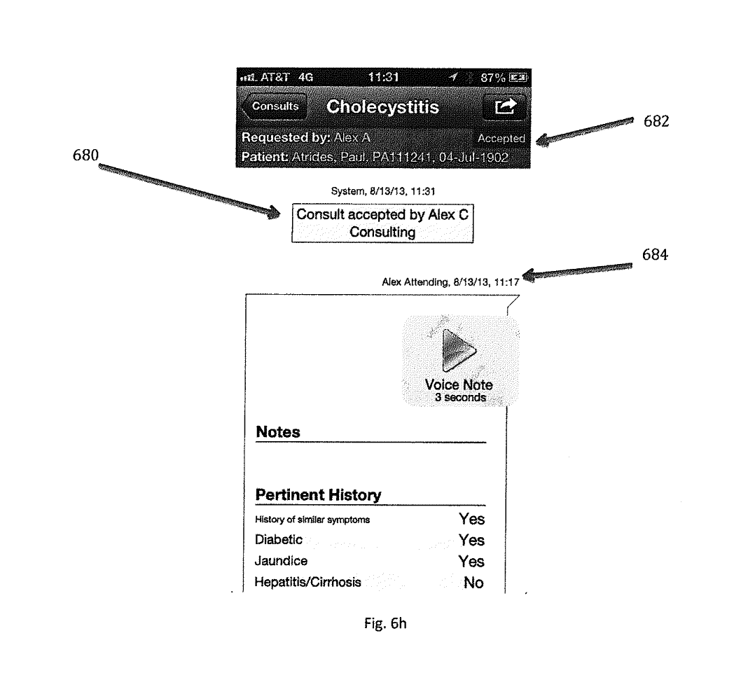

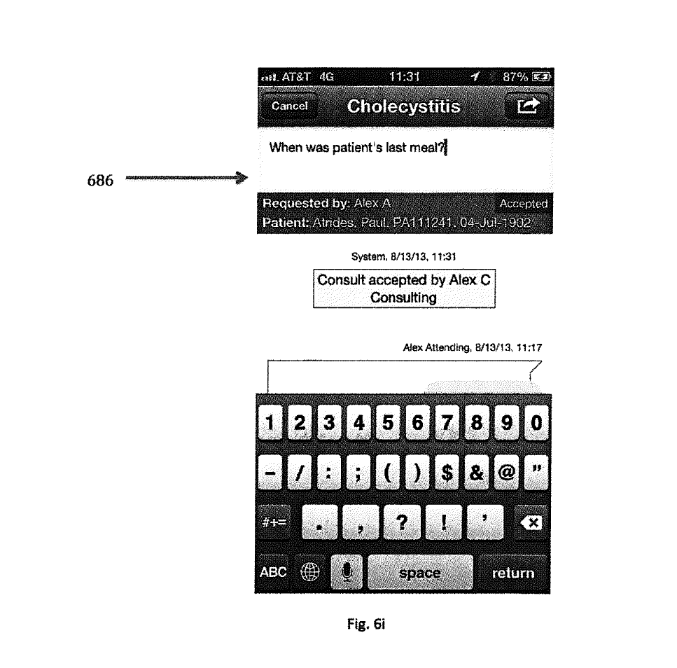

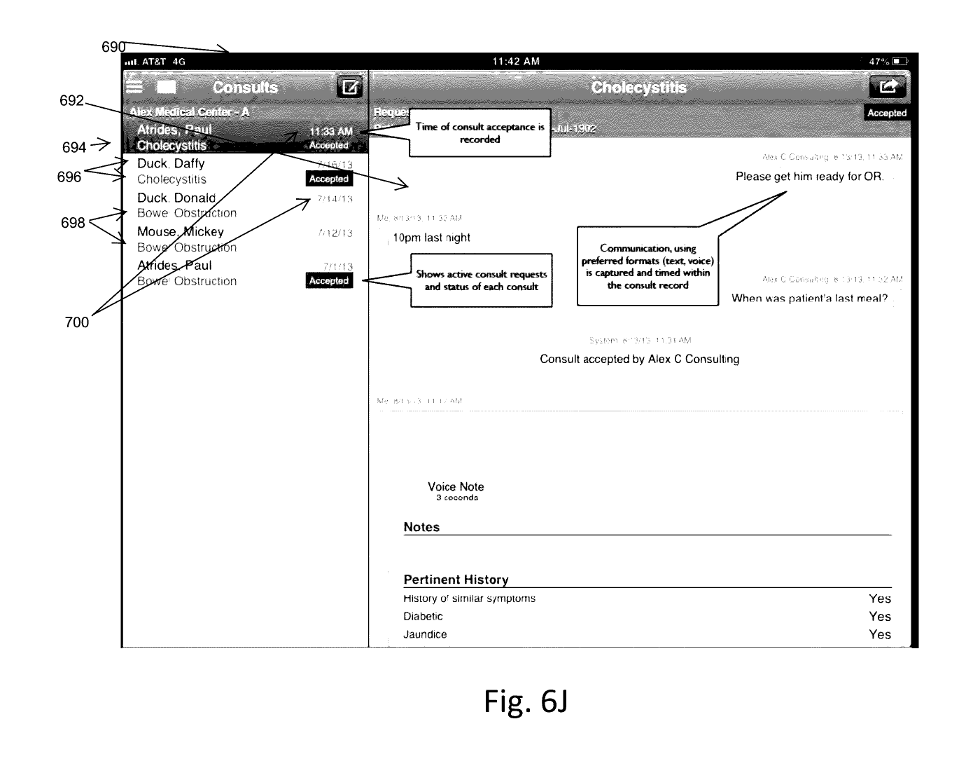

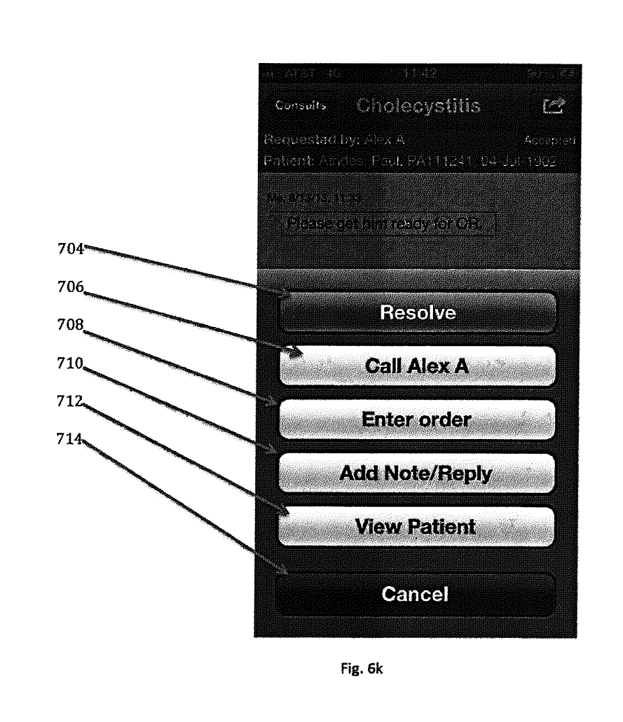

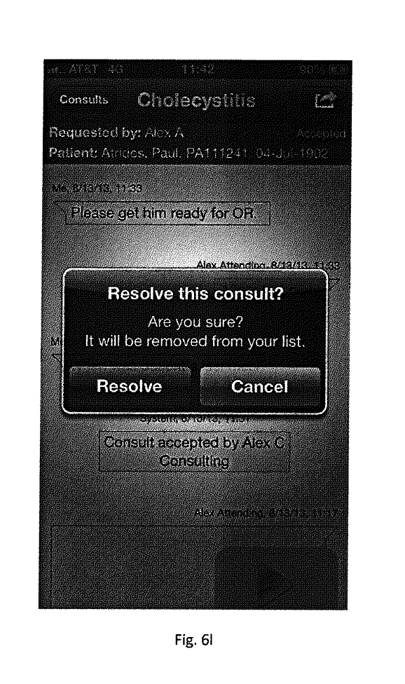

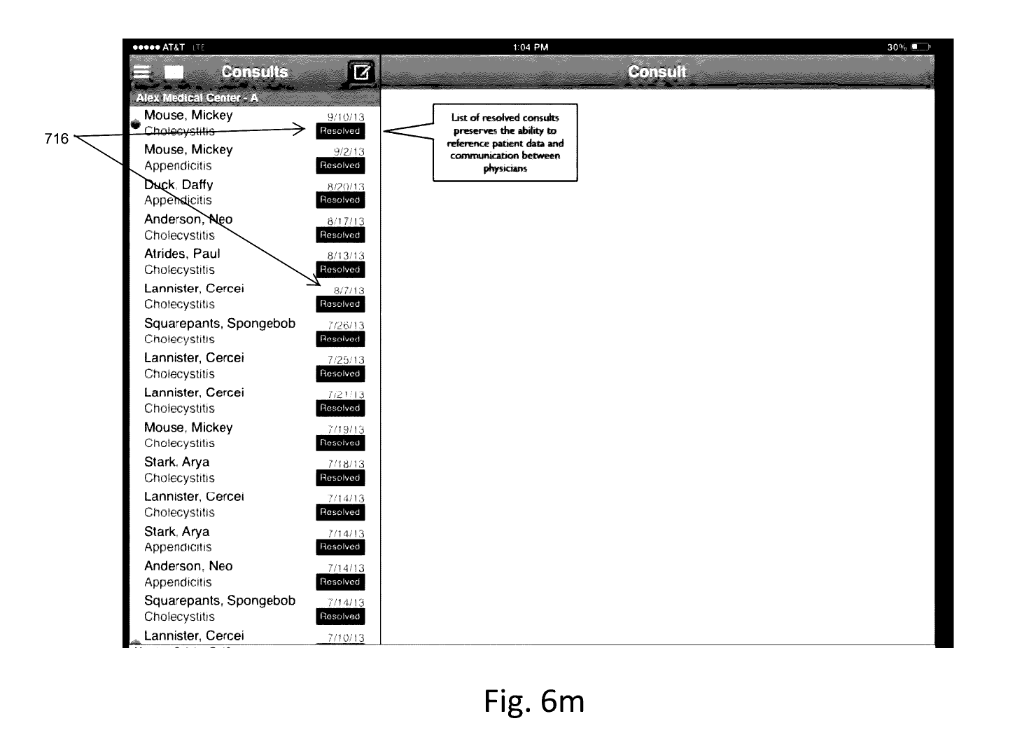

Reference is now made to FIGS. 6a-6m that illustrate exemplary but not exclusive screen shots of the exemplary user interface and templates displayed on the mobile device 102 for a consultation procedure.

FIG. 6a illustrates a main menu 600 having a submenu for a list of assigned patients 602, a list of completed consults 604, a patient directory of all patients 608, a provider directory 606, and a list of available templates 610. Field 612 depicts which physician is currently logged in.

FIG. 6b illustrates an exemplary dialog box for initiating a new consult. The dialog box includes a patient name field 614, a provider who is being consulted field 616, and a template field 618.

FIG. 6c illustrates a exemplary dialog box for diagnostic template selection. The exemplary but not exclusive template selection includes one for appendicitis field 620, one for bowel obstruction field 622, and one for cholecystitis field 624.

FIG. 6d illustrates an exemplary dialog box for initiating a new consult, with an exemplary cholecystitis template from the list of available templates 630. The exemplary but not exclusive template includes a patient name field 632, a provider who is being consulted field 634, a diagnosis field 636, free text notes field 638, a pertinent patient history field 640, a pertinent vital signs field 642, a pertinent physical exam findings field 644, and a laboratory studies field 646. While the template fields described above were specifically tailored for cholecystitis, it should be understood that each template in template submenu 310 preferably has general fields applicable across all illnesses as well as fields specifically relevant to the diagnosis. It should also be understood that any vital sign or laboratory study field may be automatically updated through an interface with the EMR server 106, alerts sent to the user, and results viewed directly, thus facilitating patient care.

FIG. 6e illustrates a exemplary but not exclusive set of options to send the consult, which include but are not limited to including a voice note field 648, sending the consult as is field 650, and sending the consult and immediately initiating a call to whom the consult is being sent field 652.

FIG. 6f illustrates an exemplary screen on the receiver's device showing a list of consults in various stages of resolution. Field 654 shows consults that have not been reviewed, as indicated by a blue dot or other marker. Field 656 demonstrates the status of the set of consults, with several being depicted as “accepted.” Field 658 depicts a time/date stamp indicating the time of consult receipt by server 106. Fields 660 and 662 indicate the patient name and condition for which the consult is being requested, and field 664 depicts the location of origin for the consult.

FIG. 6g presents and exemplary consult review screen. Depicted are the consult requestor field 670, patient name and supporting data field 672, and consult status field 674. The completed consult template is depicted in field 676, showing, in this case, the presence of a voice note field 678 as well as the exemplary consult fields as discussed for FIG. 6d.

FIG. 6h depicts a consult that has been accepted by the received, as indicated by field 680 and field 682, along with a time and date stamp field 684.

FIG. 6i demonstrates the ability to communicate about a patient and their condition using, but not limited to, secure text messaging field 686.

FIG. 6j illustrates an example of a sender's screen after consult acceptance, as seen in field 690. Also depicted is the communication thread in field 692 showing exchanged messages. Field 694 depicts the sender's list of active consults with patient name field 696, condition 698, time/date stamp field 700, and consult status field 702.

FIG. 6k exemplifies a version of the receiver's screen that depicts, but is not limited to, further options for addressing the consult in question, including the ability to resolve the consult field 704, call the sender field 706, enter an order into the EMR field 708, send a text reply field 710, the ability to view additional patient care data through the EMR or derived from the EMR field 712, and the ability to cancel the options screen field 714.

FIG. 6l exemplifies a screen prior to completing resolution of a consult, as depicted in FIG. 6k field 704.

FIG. 6m illustrates list of consults that have been resolved, as indicated in the status box field 716.

In some embodiments principles of the present disclosure provide methods and systems for tracking hours and procedures performed by an individual, such as a trainee, incuding but not limited to a resident. In this embodiment, for instance, will track the number of procedures of a given type a trainee (resident) has performed and notify nursing and the rest of the patient care team if trainees' numbers are below the minimally accepted threshold for independence.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A communications platform for patient data transfer between healthcare practitioners comprising:
at least one mobile device for supplying and receiving patient data;
a middle-tier server wirelessly coupled to the at least one mobile device;
an electronic medical record server coupled to the middle-tier server, for serving patient medical records and for storing completed healthcare practitioner input; and,
a physician directory server coupled to the middle-tier server, for serving physician availability data.

2. The communications platform of claim 1, wherein the electronic medical record server and physician directory server are combined into a single server having a database that supplies both electronic medical records and physician directory services.

3. The communications platform of claim 1, wherein the physician directory server accommodates a call schedule indicating which physician is on call for a specific specialty at a given time.

4. A method of patient hand-off by an outgoing physician on a wireless mobile communications platform comprising:
(a) accessing a middle-tier server with a computing device to select a list of patients needed to be handed off to an oncoming physician;
(b) initiating automated extraction of essential hand-off data from a database on an electronic medical record server based on diagnosis;
(c) pushing the list of patients and patient care data to an oncoming physician in a secure fashion; and,
(d) acknowledging receipt of the hand-off assignment by the oncoming physician, review the hand-off data sent by the outgoing physician, and if appropriate, accepting patient responsibility.

5. A method of claim 4 further comprising a step of discussing each patient, if needed, with the outgoing physician handing the patient off using several modalities, including text message, phone call, or voice drop.

6. A method of claim 4 wherein step (c) further comprises editing data and adding any essential care points not available in the electronic medical record server by the outgoing physician before pushing the list of patients and patient care data to the oncoming physician in a secure fashion.

7. A method of claim 4 further comprising a step of searching the electronic medical record server for additional patient data that can then be securely, efficiently, and directly incorporated into the handoff record for each patient.

8. A method of claim 4 further comprising a step of sharing patient handoff data with members of the patient care team, including nurses and physician extenders.

9. A method of patient consultation on a wireless mobile communications platform comprising:
(a) initiating a request for consultation by opening an application on a device appropriately networked to a middle-tier server;
(b) selecting an appropriate consulting physician from a directory of available consulting physicians served up by the middle-tier server from a database and initiating the request by call, text or other appropriate communication;
(c) selecting a diagnosis and patient template served up by the middle-tier server and populating patient electronic medical record data pulled from the database;
(d) reviewing the patient electronic medical record data for accuracy; and,
(e) sending out the data reviewed in step (d) by at least one modality of call, text or page to a requested consulting physician.

10. A method of claim 9 further comprising a step of adding or supplementing patient electronic medical record data by adding a voice message or electronic note.

11. A method of claim 9 further comprising a step of reporting out activity and analysis from the middle-tier server.

12. A method of claim 9 further comprising a step of activating an auto-reminder to watchdog whether a requested consulting physician responds.

13. A method of claim 9 further comprising a step of receiving notice of acceptance or rejection from the requested consulting physician.

14. A method of claim 13 further comprising a step of selecting another consulting physician if the requested consulting physician rejects the request.

15. A method of claim 14 wherein the step of selecting another consulting physician is performed by a system auto-escalation mechanism.

16. A method of claim 13 further comprising a step of responding to an action order if the requested consulting physician accepted the assignment.

17. A method of claim 13 further comprising a step of auto-reminding to alert the requesting physician that the consulting physician accepted the assignment but has yet to issue an action order.

18. A method of claim 13 further comprising a step of notifying the requesting physician that the consulting physician has arrived at a patient's bedside.

19. A method of claim 18 wherein the step of notifying the requesting physician is through a Global Positioning System technique.

20. A method of claim 19 wherein the step of notifying the requesting physician is through a micro-location Wi-Fi technique.
